(19) United States
(12) Patent Application Publication
(10) Pub. No.: US 2026/0192850 A1
(43) Pub. Date: Jul. 9, 2026

(54) ROTARY STEERING SYSTEMS

(71) Applicant: Ford Global Technologies, LLC, Dearborn, MI (US)

(72) Inventor: Joseph Washnock, Canton, MI (US)

(21) Appl. No.: 19/013,887

(22) Filed: Jan. 8, 2025

(51) Int. Cl. B62D 5/00

(52) U.S. Cl. CPC B62D 5/008

(57) ABSTRACT

Rotary steering systems are disclosed. An example steering gear disclosed herein includes a first shaft to be coupled to a steering shaft, a second shaft to be coupled to a steering linkage, an input gear set coupling the first shaft to the second shaft, a motor, a first planetary gear set coupled to the motor, and a second planetary gear set coupled to the second shaft, the second planetary gear set coaxially aligned with the first planetary gear set.

### FIELD OF THE DISCLOSURE

This disclosure relates generally to steering systems and, more particularly, to rotary steering systems.

### BACKGROUND

Some known vehicles include mechanical linkages that connect the front wheels of a vehicle to a steering wheel. These mechanical linkages allow a driver to adjust the orientation of the front wheels of the vehicle by rotating the steering wheel. For example, many known steering systems include rack and pinion gears that translate the rotational motion of a steering wheel to linear actuation or movement of a drag link and/or tie rods connected to the front wheels. As the steering wheel rotates, the drag link and/or the tie rods change the angular orientation of the wheels and steer the vehicle.

### SUMMARY

An example steering gear disclosed herein includes a first shaft to be coupled to a steering shaft, a second shaft to be coupled to a steering linkage, an input gear set coupling the first shaft to the second shaft, a motor, a first planetary gear set coupled to the motor, and a second planetary gear set coupled to the second shaft, the second planetary gear set coaxially aligned with the first planetary gear set.

An example vehicle disclosed herein includes a steering shaft, a steering linkage, and a steering gear assembly including a first shaft coupled to the steering shaft, a second shaft coupled to the steering linkage, an input gear set coupling the first shaft to the second shaft, a motor, a first planetary gear set coupled to the motor, and a second planetary gear set coupled to the second shaft, the second planetary gear set coaxially aligned with the first planetary gear set.

### BRIEF DESCRIPTION OF THE DRAWINGS

FIG. 1A illustrates a vehicle including a steering system implemented in accordance with teachings of this disclosure.

FIG. 1B is a schematic diagram of the steering system of FIG. 1A including a steering gear assembly implemented in accordance with teachings of this disclosure.

FIG. 2 is a perspective view of the steering gear assembly of FIG. 1B.

FIG. 3 is a side view of the steering gear assembly of FIG. 2.

FIGS. 4A and 4B are detail views of a first planetary gear set and a second planetary gear set of the steering gear assembly of FIGS. 2 and 3.

FIGS. 5A and 5B are detail views of a third planetary gear set of the steering gear of FIGS. 2 and 3.

In general, the same reference numbers will be used throughout the drawing(s) and accompanying written description to refer to the same or like parts. The figures are not necessarily to scale.

### DETAILED DESCRIPTION

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein in the context of describing the position and/or orientation of a first object, plane, or axis relative to a second object, plane, or axis, the term “substantially perpendicular” encompasses the term perpendicular and more broadly encompasses a meaning whereby the first object, plane, or axis is positioned and/or oriented relative to the second object, plane, or axis at an absolute angle of no more than ten degrees (10°) from perpendicular. For example, a first axis that is substantially perpendicular to a second axis is positioned and/or oriented relative to the second axis at an absolute angle of no more than ten degrees (10°) from perpendicular.

As used herein in the context of describing the position and/or orientation of a first object, plane, or axis relative to a second object, plane, or axis, the term “substantially parallel” encompasses the term parallel and more broadly encompasses a meaning whereby the first object, plane, or axis is positioned and/or oriented relative to the second object, plane, or axis at an absolute angle of no more than ten degrees (10°) from parallel. For example, a first axis that is substantially parallel to a second axis is positioned and/or oriented relative to the second axis at an absolute angle of no more than ten degrees (10°) from parallel. Accordingly, as used herein, the term “non-parallel” encompasses the first object, plane, or axis not being within ten degrees (10°) of parallel to the second object, plane, or axis.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Some heavy-duty trucks include a steering mechanism including hydraulically assisted recirculating ball (RCB) gears or worm and wheel steering gears. In such systems, a pump provides hydraulic assistance to the RCB gears by pumping hydraulic steering fluid through the steering system. As the steering wheel of the vehicle is turned, a steering shaft rotates to cause a ball nut of the RCB gears to move linearly. In turn, the ball nut rotates a sector gear and/or shaft that is coupled to a pitman arm that turns the wheels. The hydraulic steering fluid is pumped to assist the movement of the ball nut based on the rotation of the steering shaft. Hydraulic-assisted RCB gears provide high amounts of steering power but often lack precise steering feedback. Some trucks with hydraulic-assisted RCB gears include electronic torque overlay devices that enhance the steering feel associated with such systems. However, such torque overlay systems have large packaging space requirements and increase the complexity of the steering system. Other heavy-duty trucks include fully electric steering gear systems, which can have a limited range of motion and have large packaging space requirements.

Examples disclosed herein overcome some or all of the above-noted deficiencies and include an electric-assisted rotary steering gear. Example steering gear assemblies disclosed herein include three planetary gear sets that increase the gear ratio of an electric assistance motor. In some examples disclosed herein, the three planetary gear sets, the motor, and the sector shaft of the steering gear assembly are coaxially aligned. In some examples disclosed herein, the steering gear assembly includes an input shaft including a pinion that is engaged with a sector gear of the steering gear assembly. Example steering gear assemblies disclosed herein are compact and can be mounted on the frame and/or body of a vehicle in a variety of positions. Example steering gear assemblies disclosed herein provide sufficient power for use in heavy vehicles, such as heavy-duty trucks. Example steering gears disclosed herein do not include ball nuts, which enables the system to occupy comparatively less space in an under-hood environment of the vehicle than prior steer gears and reduces losses to friction within the ball nut.

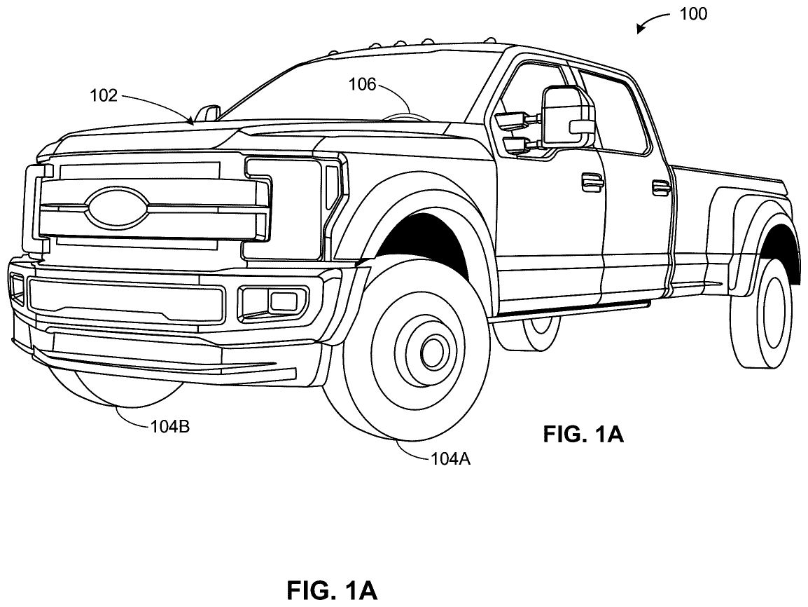

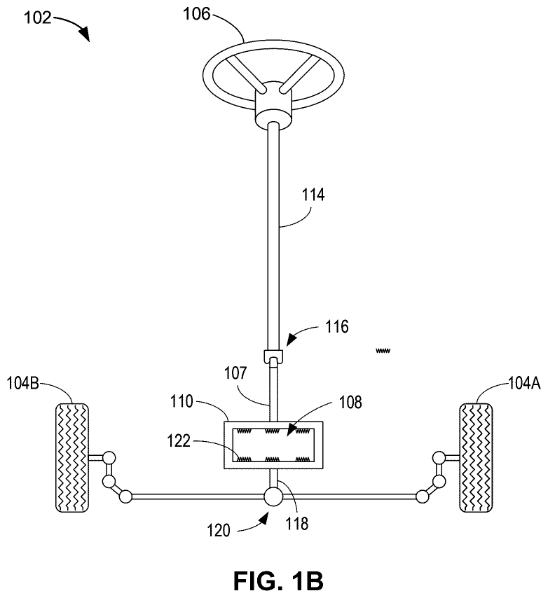

FIG. 1A is a perspective view of an example vehicle 100 in which teachings of this disclosure can be implemented. In the illustrated example of FIG. 1A, the vehicle 100 includes an example steering system 102, an example first wheel 104A, and an example second wheel 104B. In the illustrated example of FIG. 1A, the example vehicle 100 is a pick-up truck. In other examples, the vehicle 100 can be any type of vehicle (e.g., a van, a coupe, a sedan, a sports utility vehicle (SUV), a semi-trailer truck, a mini-van a railed vehicle, an all-terrain vehicle (ATV), watercraft, construction equipment, farming equipment, etc.). In the illustrated example of FIG. 1A, the vehicle 100 is a two-axle vehicle. In other examples, the vehicle 100 can have additional axles and/or additional wheels. The example vehicle 100 can have a body-on-frame construction and/or a unibody construction.

In the illustrated example of FIG. 1A, the steering system 102 includes an example steering wheel 106 to transmit driver inputs to the steering system 102 (e.g. by rotating the steering wheel, etc.). The steering system 102 receives these user inputs via the steering wheel 106, transforms the input into a lateral force via a steering gear, and rotates the wheels 104A, 104B to change the direction of the vehicle 100. The steering system 102 is described in additional detail below in conjunction with FIG. 1B. While the steering system 102 is used to control a front axle of the vehicle 100, examples disclosed herein are also applicable to steering systems associated with rear-steered axles.

FIG. 1B is a schematic diagram of the steering system 102 of FIG. 1A. In the illustrated example of FIG. 1B, the steering system 102 includes the steering wheel 106 of FIG. 1A, an example input shaft 107, an example steering gear assembly 108, an example housing 110, an example steering shaft 114, an example joint 116, an output shaft 118, and example steering linkages 120.

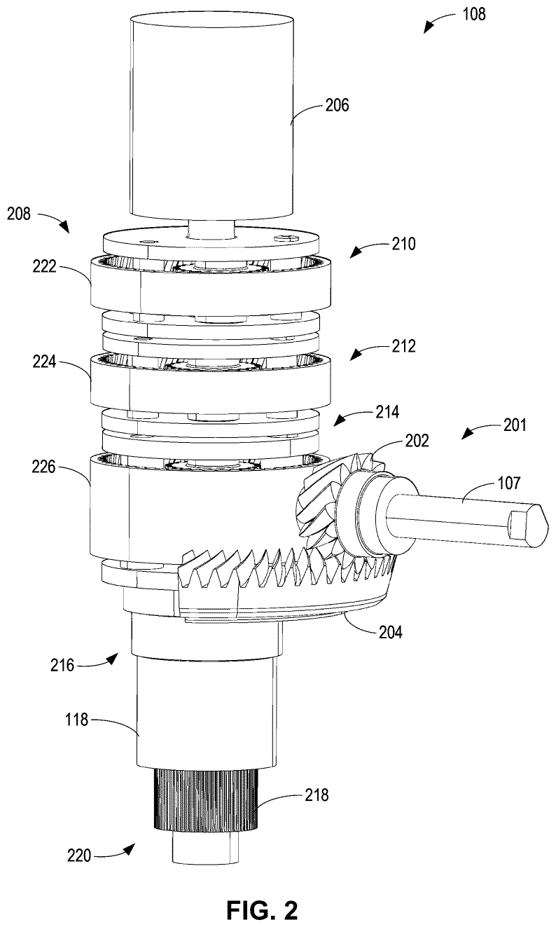

In the illustrated example of FIG. 1B, the steering gear assembly 108 is positioned within the housing 110 (e.g., disposed within the housing 110, housed within the housing 110, etc.). The steering gear assembly 108 includes a rotary steering gear that converts the rotational motion of the input shaft 107 into the lateral motion of the steering linkages 120 of the steering system 102. In some examples, the lateral force output by the steering gear assembly 108 turns the wheels of the wheels 104A, 104B of the vehicle 100, which controls the direction of travel of the vehicle 100. The steering gear assembly 108 includes a gear train that includes a plurality of stacked (e.g., coaxially aligned, etc.) planetary gear sets disposed in sequence. The stacking of multiple planetary gear sets enables the steering gear assembly 108 to be more compact than prior steering gears of heavy vehicles (e.g., recirculating ball steering gears, etc.). The comparatively small size of the steering gear assembly 108 enables the steering gear assembly 108 to be positioned within relatively small spaces in an under-hood environment of the vehicle 100 while still providing sufficient steering assistance to turn the wheels of heavy trucks (e.g., the wheels 104A, 104B of the vehicle 100, etc.). In some examples, the steering gear assembly 108 has an assistance gear ratio of greater than 100:1. In some such examples, the high gear ratio of the steering gear assembly 108 enables a comparatively small electric steering assistance motor to be included therein. The steering gear assembly 108 is described below in additional detail in conjunction with FIGS. 2-5B.

The housing 110 contains and/or supports the steering gear assembly 108. In some examples, the housing 110 is mounted on a body and/or frame of the vehicle 100. In the illustrated example of FIG. 1B, the housing 110 is a single integral component. In other examples, the housing 110 includes one or more components (e.g., one or more distinct components, etc.), which can be joined via one or more fasteners, one or more welds, one or more chemical adhesives, etc. In some examples, the housing 110 can be mounted to a frame and/or body of the vehicle 100 via one or more fasteners, one or more welds, one or more chemical adhesives, etc. In the illustrated example of FIG. 1B, the interior of the housing 110 includes a plurality of teeth sets 122, which interface with corresponding gear(s) of the steering gear assembly 108. In the illustrated example of FIG. 1B, the housing 110 includes three teeth sets 122, which engage with the planet gears of the steering gear assembly 108. In other examples, the housing 110 can include a different quantity of teeth sets (e.g., one teeth set, two teeth sets, etc.). In other examples, the teeth sets 122 are absent.

In the illustrated example of FIG. 1B, the input shaft 107 of the steering system 102 protrudes from the housing 110. In the illustrated example of FIG. 1B, the input shaft 107 is coupled to the steering shaft 114 via the joint 116. In the illustrated example of FIG. 1B, the joint 116 is a U-joint. In the illustrated example of FIG. 1B, the steering shaft 114 is operatively coupled to the steering wheel 106 of the vehicle 100. In some examples, the input shaft 107 rotates with the steering shaft 114 as a driver rotates the steering wheel 106. In turn, the steering system 102 converts the rotation of the steering wheel 106 to a rotation of the wheels of the vehicle 100 to steer the vehicle. Additionally or alternatively, the steering system 102 can cause the wheels 104A, 104B of the vehicle to rotate without the rotation of the steering wheel 106 (e.g., the vehicle 100 is a steer-by-wire system, etc.). In some examples, the steering system 102 includes additional intermediate shafts disposed between the steering shaft 114 and the input shaft 107.

The output shaft 118 is coupled to the steering gear assembly 108 and the steering linkages 120 (e.g., the output shaft 118 couples the steering gear assembly 108 to the steering linkages 120, etc.). As used herein, the output shaft 118 is also referred to as the “sector shaft” and the “sector trunnion shaft.” The steering linkages 120 are a plurality of mechanical parts that couple the output shaft 118 of the steering gear assembly 108 to the wheels 104A, 104B. In some examples, the steering linkages 120 can include one or more control arms, one or more pitman arms, one or more drag links, one or more tie rods, one or more joints, etc. The steering linkages 120 enable an output of the steering gear assembly 108 to change the direction of the wheels 104A, 104B, which changes the direction of the vehicle 100.

FIG. 2 is a perspective view of the steering gear assembly 108 of FIG. 1B. In the illustrated example of FIG. 2, the steering gear assembly 108 includes the input shaft 107 of FIG. 1B and the output shaft 118 of FIG. 1B. In the illustrated example of FIG. 2, the input shaft 107 is rigidly coupled to an example input gear set 201. In the illustrated example of FIG. 2, the input gear set 201 includes an example input pinion 202 and an example sector gear 204. In the illustrated example of FIG. 2, the steering gear assembly 108 includes an example motor 206 and an example gear train 208. In the illustrated example of FIG. 2, the gear train 208 includes an example first planetary gear set 210, an example second planetary gear set 212, and an example third planetary gear set 214. In the illustrated example of FIG. 2, the output shaft 118 is rigidly coupled to the sector gear 204 at a first longitudinal end 216 and includes example splines 218 positioned at a second longitudinal end 220.

The input gear set 201 couples the input shaft 107 to the steering gear assembly 108. In the illustrated example of FIG. 2, the input gear set 201 is coupled to the input shaft 107 via the input pinion 202 and is coupled to the output shaft 118 via the sector gear 204. In the illustrated example of FIG. 2, the input pinion 202 is engaged with (e.g., enmeshed with, etc.) with the sector gear 204. In the illustrated example of FIG. 2, the teeth of the input pinion 202 and the sector gear 204 have a spiral bevel. In other examples, the teeth of the input pinion 202 and the sector gear 204 have a straight bevel, a hypoid bevel, a miter bevel, and/or a zirol bevel. In other examples, the input pinion 202 is absent and the input shaft 107 includes a worm gear that is enmeshed with the sector gear 204. In the illustrated example of FIG. 2, the sector gear 204 is integral with the output shaft 118. In other examples, the sector gear 204 and the output shaft 118 are discrete components coupled via one or more welds, one or more fasteners, one or more chemical adhesives, one or more interference fits, etc. In the illustrated example of FIG. 2, the sector gear 204 extends circumferentially around approximately one-third (e.g., 33%, etc.) of the output shaft 118. In other examples, depending on the intended travel of the steering system 102, the sector gear 204 can extend along a different circumferential portion of the output shaft 118 (e.g., 20%. 40%, 50%, 75%, etc.).

The motor 206 provides assistance steering torque to the steering gear assembly 108 to assist the rotation of the output shaft 118. The motor 206 applies force to the steering gear assembly 108. In the illustrated example of FIG. 2, the motor 206 is an electric motor. In some examples, the motor 206 can be powered via one or more batteries of the vehicle 100 (e.g., a starting, lighting, and ignition (SLI) battery of the vehicle 100, a battery of a battery electric vehicle (BEV), etc.). Additionally or alternatively, the motor 206 can be powered by an alternator of the vehicle 100. In other examples, the motor 206 is implemented by a pneumatic and/or hydraulic actuator associated with the vehicle 100.

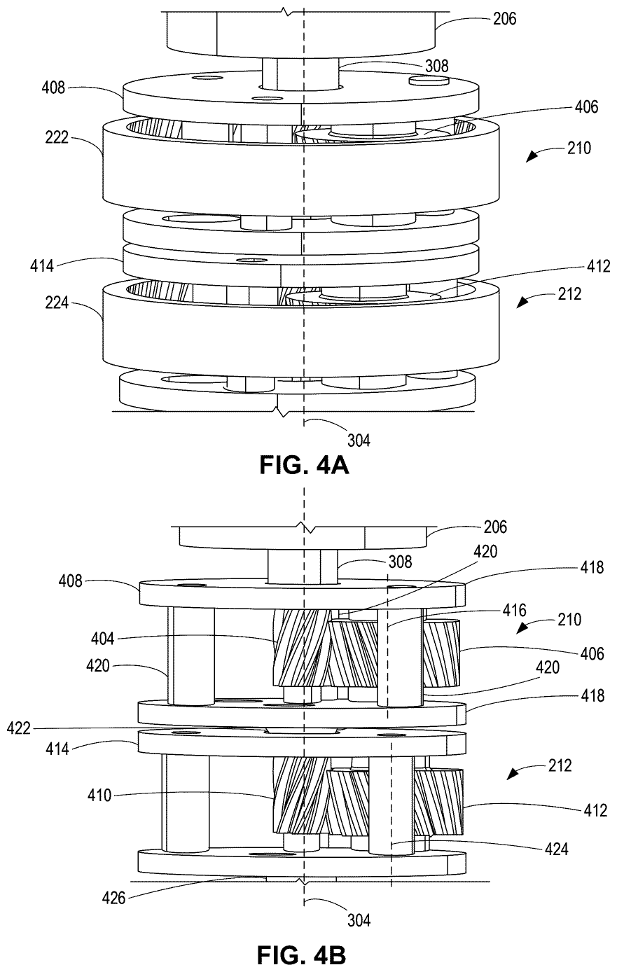

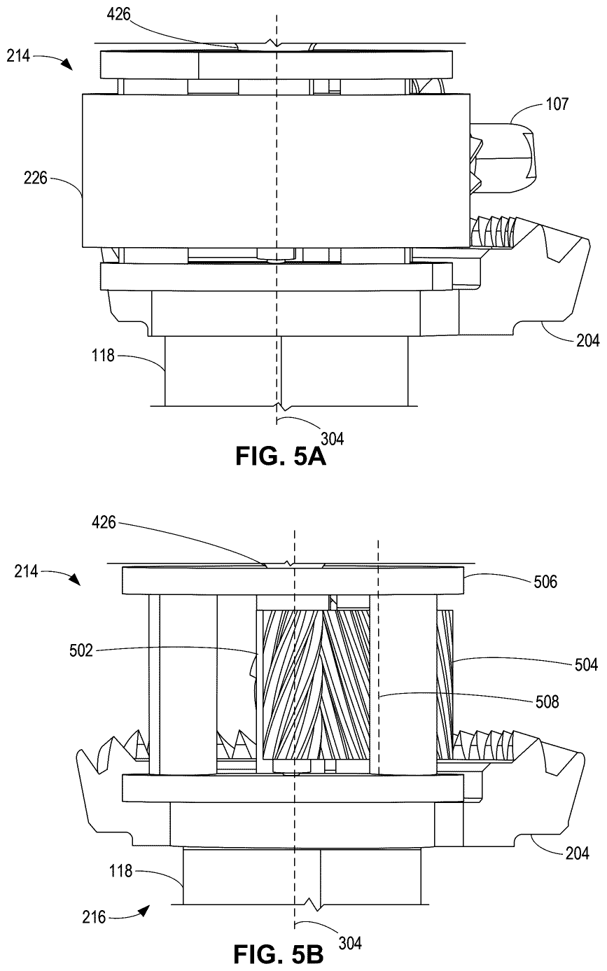

The gear train 208 is disposed between and couples the motor 206 and the output shaft 118. In the illustrated example of FIG. 2, the first planetary gear set 210 (e.g., a first epicyclic gear set, etc.) is coupled to the motor 206 and the second planetary gear set 212. In the illustrated example of FIG. 2, the second planetary gear set 212 (e.g., a second epicyclic gear set, etc.) is coupled to the first planetary gear set 210 and the third planetary gear set 214. In the illustrated example of FIG. 2, the third planetary gear set 214 (e.g., a third epicyclic gear set, etc.) is coupled to the second planetary gear set 212 and the output shaft 118. During operation, the gear train 208 provides a gear reduction of the rotation of the motor 206 and increases the torque applied by the motor 206 to the output shaft 118. For example, the gear train 208 can apply a gear reduction ratio of at least 100:1 to the rotation of the motor 206. In other examples, the gear train 208 is configured to have a different gear reduction ratio (e.g., 10:1, 50:1, 200:1, etc.). In the illustrated example of FIG. 2, the gear train 208 includes three planetary gear sets (e.g., the planetary gear sets 210, 212, 214, etc.). In other examples, the gear train 208 can include a different quantity of planetary gear sets (e.g., 2 planetary gear sets, 4 planetary gear sets, etc.) depending on the desired reduction ratio of the gear train 208. The planetary gear sets 210, 212, 214 are described below in additional detail in conjunction with FIGS. 4A-5B.

In the illustrated example of FIG. 2, the planetary gear sets 210, 212, 214 include an example first ring gear 222, an example second ring gear 224, and an example third ring gear 226, respectively. The ring gears 222, 224, 226 include teeth disposed on the inner diameter thereof, which engage with the planet gears of the planetary gear sets 210, 212, 214, respectively. The relationship between the ring gears 222, 224, 226 and the other gears of the planetary gear sets 210, 212, 214 are described below in conjunction with FIGS. 4A-5B.

In the illustrated example of FIG. 2, the ring gears 222, 224, 226 are discrete components (e.g., the first ring gear 222 is discrete from the second ring gear 224 and the third ring gear 226, etc.). In other examples, the ring gears 222, 224, 226 can be implemented by one or two components. For example, the ring gears 222, 224, 226 can be implemented by a single cylindrical component extending between each of the planetary gear sets 210, 212, 214. In other examples, the steering gear assembly 108 includes a third ring gear 226 and a cylindrical component including teeth engaged with the first planetary gear set 210 and the second planetary gear set 212 or the first ring gear 222 and a cylindrical component including teeth engaged with the second planetary gear set 212 and the third planetary gear set 214. In some examples, the ring gears 222, 224, 226 are rigidly coupled to a housing of the steering gear assembly 108 (e.g., the housing 110 of FIG. 1B, etc.). For example, some or all of the ring gears 222, 224, 226 can be integral with the housing 110 and/or coupled thereto via one or fasteners, one or more welds, one or more chemical adhesives, one or more interference fits. In other examples, some or all of the ring gears 222, 224, 226 are absent. In some such examples, the planet gears of the planetary gear sets 210, 212, 214 can be engaged with teeth disposed on the interior surface of the housing 110 (e.g., engaged with one or more of the teeth sets 122 of FIG. 1B, etc.).

During operation, the input shaft 107 rotates in response to the rotation of the steering wheel 106 of FIG. 2, which causes corresponding rotation of the input pinion 202. The rotation of the input pinion 202 applies a torque to the sector gear 204 and causes a corresponding rotation of the output shaft 118 and the splines 218. In some examples, the splines 218 can be coupled to a steering linkage (e.g., a pitman arm, etc.) of the steering linkages 120 of FIG. 1B. In some examples, the splines 218 are absent. In other such examples, the output shaft 118 is coupled to the steering linkages 120 via a different connection (e.g., one or more fasteners, one or more welds, one or interference fits, one or more U-joints, a clutch, a gear-interface, etc.). The rotation of the output shaft 118 causes a corresponding pivoting of the steering linkages 120 of FIG. 1 and a corresponding rotation of the wheels 104A, 104B. The motor 206 rotates the gears of the gear train 208, which in turn rotate and provide assistance torque to the output shaft 118 (e.g., the gear train 208 and the motor 206 increase the torque applied to the output shaft 118 by the steering gear assembly 108, etc.).

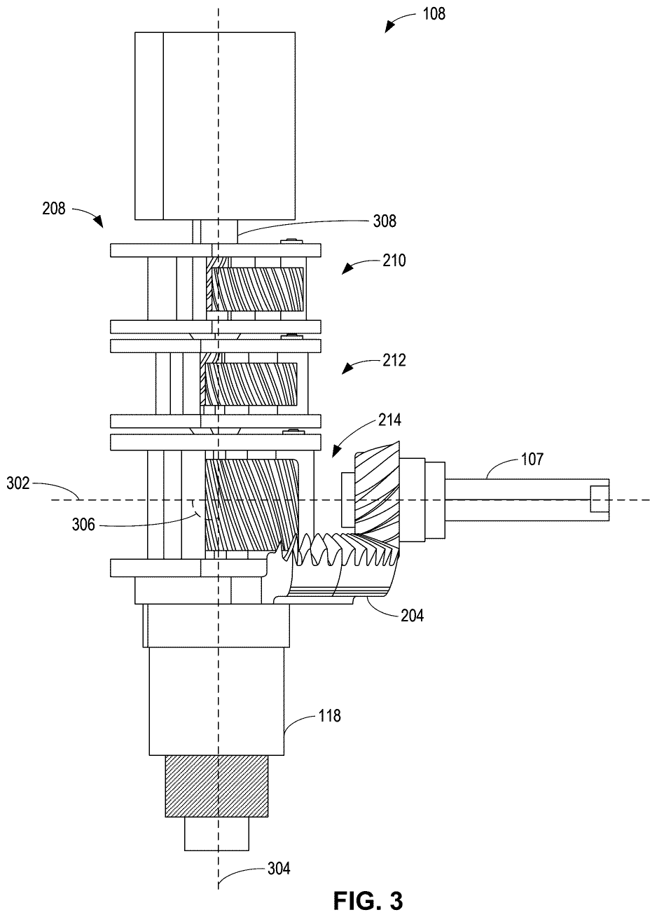

FIG. 3 is a side view of the steering gear assembly 108 of FIG. 2. In the illustrated example of FIG. 3, the input shaft 107 is disposed along an example first axis 302 and the output shaft 118 is disposed along an example second axis 304. In the illustrated example of FIG. 3, the first axis 302 and the second axis 304 form an example angle 306. In the illustrated example of FIG. 3, the motor 206 includes an example motor shaft 308. In the illustrated example of FIG. 3, the first axis 302 and the second axis 304 are substantially perpendicular (e.g., orthogonal, etc.). That is, the angle 306 is approximately ninety degrees. In other examples, the angle 306 is not perpendicular (e.g., the angle 306 is acute, the angle is obtuse, etc.). In the illustrated example of FIG. 3, the first planetary gear set 210, the second planetary gear set 212, the third planetary gear set 214, the motor shaft 308, and the output shaft 118 are aligned along the second axis 304. That is, the first planetary gear set 210, the second planetary gear set 212, the third planetary gear set 214, the motor shaft 308, and the output shaft 118 are coaxially aligned (e.g., coaxial, inline, stacked, etc.). For example, the sun gears of the first planetary gear set 210, the second planetary gear set 212, and the third planetary gear set 214 are centered along the second axis 304 (e.g., concentric, etc.). In the illustrated example of FIG. 3, the sector gear 204 is concentric with the output shaft 118. The geometric relationship of the first planetary gear set 210, the second planetary gear set 212, the third planetary gear set 214, the motor shaft 308, and the output shaft 118 reduces the packaging space of the steering gear assembly 108 and facilitates the deposition thereof within the housing 110.

FIGS. 4A and 4B are detail views of the first planetary gear set 210 and the second planetary gear set 212 of the steering gear assembly 108 of FIGS. 1-3. FIG. 4A is a detail view of the planetary gear sets 210, 212 including the ring gears 222, 224. FIG. 4B is a detail view of the planetary gear sets 210, 212 in which the ring gears 222, 224 are removed for visual clarity. In the illustrated example of FIGS. 4A and 4B, the motor 206 includes the motor shaft 308 of FIG. 3 extending therefrom along the second axis 304 of FIG. 3B. In the illustrated example of FIGS. 4A and 4B, the first planetary gear set 210 includes an example first sun gear 404 (not visible in FIG. 4A), an example first planet gear 406, an example first carrier 408, and the first ring gear 222 of FIG. 2 (not visible in FIG. 4B). In the illustrated example of FIGS. 4A and 4B, the second planetary gear set 212 includes an example second sun gear 410 (not visible in FIG. 4A), an example second planet gear 412, an example second carrier 414, and the second ring gear 224 of FIG. 2 (not visible in FIG. 4B). It should be appreciated that the planetary gear sets 210, 212 include additional planet gears (e.g., in addition to the planet gears 406, 412, etc.) that are engaged with the sun gears 404, 410, respectively, which are not depicted for visual clarity. In the illustrated example of FIGS. 4A and 4B, the planetary gear sets 210, 212 are sized to include three planet gears. In other examples, the planetary gear sets 210, 212 can include any suitable number of planet gear(s) (e.g., two planet gears, four planet gears, eight planet gears, etc.).

The first sun gear 404 of the first planetary gear set 210 is rigidly coupled to the motor shaft 308 (e.g., the first sun gear 404 is coupled to the motor via the motor shaft 308, etc.). The first sun gear 404 is engaged with the first planet gear 406 and the planet gears of the first planetary gear set 210. In some examples, the first sun gear 404 is supported by a bearing of the first carrier 408, which enables the relative rotation thereof. In the illustrated example of FIGS. 4A and 4B, the first planet gear 406 and the other planet gears of the first planetary gear set 210 are supported by bearings within the first carrier 408, which enables the planet gears of the first planetary gear set 210 to rotate about the corresponding the centerline axes thereof. In the illustrated example of FIG. 4A, the first planet gear 406 is engaged with the first ring gear 222. In other examples, the first planet gear 406 is engaged with the teeth sets 122 of the housing 110 of FIG. 1B.

The first carrier 408 supports (e.g., carriers, etc.) the gears of the first planetary gear set 210. In the illustrated example of FIG. 4, the first carrier 408 includes two annular members 418 that are joined via three cylindrical members 420 extending therebetween. In some examples, the annular members 418 are joined to the cylindrical members 420 via one or more welds, one or more chemical adhesives, one or more interference fits, and/or one or fasteners. In other examples, the first carrier 408 can have any other suitable configuration (e.g., a different number of cylindrical members 420, etc.).

During operation, the motor 206 causes the motor shaft 308 and the first sun gear 404 to rotate about the second axis 304. In some such examples, rotation of the first sun gear 404 causes the first planet gear 406 to rotate via the engagement therewith. Because the first ring gear 222 is fixed (e.g., unable to rotate, etc.), rotation of the first planet gear 406 causes the planet gears (e.g., the first planet gear 406, etc.) to epicyclically rotate about the first sun gear 404 (e.g., rotation about the second axis 304 and the centerline axis of each planet gear, etc.). For example, during operation, the first planet gear 406 rotates about the second axis 304 and a first centerline axis 416 of the first planet gear 406. The rotation of the first planet gear 406 and the other planet gears of the first planetary gear set 210 about the second axis 304 and the first sun gear 404 causes a corresponding rotation of the first carrier 408. It should be appreciated that the number of teeth of the gears of the first planetary gear set 210 and the quantity of the planetary gears determines the gear reduction (e.g., the relative rotation rate of the motor shaft 308 and the first carrier 408, etc.) of the first planetary gear set 210.

The second sun gear 410 of the second planetary gear set 212 is rigidly coupled to an example first intermediate shaft 422. In the illustrated example of FIG. 4B, the first intermediate shaft 422 is rigidly coupled to the first carrier 408 of the first planetary gear set 210 (e.g., the second sun gear 410 is coupled to the first carrier 408 via the first intermediate shaft 422, etc.). The second sun gear 410 is engaged with the second planet gear 412 and the other planet gears of the second planetary gear set 212. In some examples, the second sun gear 410 is supported by a bearing of the second carrier 414, which enables the relative rotation thereof. In the illustrated example of FIGS. 4A and 4B, the second planet gear 412, and the other planet gears of the second planetary gear set 212 are supported by bearings within the second carrier 414, which enables the planet gears to rotate about the corresponding centerline axes thereof. In the illustrated example of FIG. 4A, the second planet gear 412 is engaged with the second ring gear 224. In other examples, the second planet gear 412 is engaged with the teeth sets 122 of the housing 110 of FIG. 1B.

The second carrier 414 supports (e.g., carries, etc.) the gears of the second planetary gear set 212. In the illustrated examples of FIGS. 4A and 4B, the second carrier 414 has the same size, shape, and components as the first carrier 408 (e.g., the second carrier 414 includes two annular members similar to the annular members 418 and three cylindrical members similar to the cylindrical members 420, etc.). In other examples, the second carrier 414 has a different size, shape, and/or component(s) than the first carrier 408.

During operation, the rotation of the first carrier 408 of the first planetary gear set 210 causes the first intermediate shaft 422 and the second sun gear 410 to rotate about the second axis 304. In some such examples, rotation of the second sun gear 410 causes the second planet gear 412 and the other planet gears of the second planetary gear set 212 to rotate via the engagement therewith. Because the second ring gear 224 is fixed (e.g., unable to rotate, etc.), rotation of the second sun gear 410 causes the planet gears (e.g., the second planet gear 412, etc.) to epicyclically rotate about the second sun gear 410 (e.g., rotation about the second axis 304 and the centerline axis of each planet gear, etc.). For example, during operation, the second planet gear 412 rotates about the second axis 304 and a second centerline axis 424 of the second planet gear 412. The rotation of the second planet gear 412 and the other planet gears of the second planetary gear set 212 about the second axis 304 and the second sun gear 410 causes a corresponding rotation of the second carrier 414. In the illustrated example of FIG. 4B, the second carrier 414 is rigidly coupled to a second intermediate shaft 426, which correspondingly rotates therewith. It should be appreciated that the number of teeth of the gears of the second planetary gear set 212 and the quantity of the planetary gears determines the gear reduction (e.g., the relative rotation rate of the first intermediate shaft 422 and the second carrier 414, etc.) of the first planetary gear set 210.

FIGS. 5a and 5B are detail views of the third planetary gear set 214 of FIGS. 2 and 3. FIG. 5A is a detail view of the third planetary gear set 214 including the third ring gear 226. FIG. 5B is a detail view of the third planetary gear set 214 in which the third ring gear 226 is removed for visual clarity. In the illustrated example of FIGS. 5A and 5B, the third planetary gear set 214 includes an example third sun gear 502 (not visible in FIG. 5A), an example third planet gear 504, an example third carrier 506, and the third ring gear 226 of FIG. 2 (not visible in FIG. 5B). It should be appreciated that the third planetary gear sets 214 include additional planet gears (e.g., in addition to the third planetary gear 504, etc.) that are engaged with the third sun gear 502, respectively, which are not depicted for visual clarity. In the illustrated example of FIGS. 5A and 5B, the third planetary gear set 214, like the first planetary gear set 210 and the second planetary gear set 212, is sized to include three planet gears. In other examples, the third planetary gear sets 214 can include any suitable number of planet gears (e.g., two planet gears, four planet gears, eight planet gears, etc.).

The third sun gear 502 of the third planetary gear set 214 is rigidly coupled to the second intermediate shaft 426 of FIG. 4B. The second intermediate shaft 426 is rigidly coupled to the second carrier 414 of the second planetary gear set 212 (e.g., the third sun gear 502 is coupled to the second carrier 414 via the second intermediate shaft 426, etc.). In the illustrated example of FIG. 5B, the third sun gear 502 is engaged with the third planet gear 504 and the other planet gears of the third planetary gear set 214. In some examples, the third sun gear 502 is supported by a bearing of the third carrier 506, which enables the relative rotation thereof. In the illustrated example of FIGS. 5A and 5B, the third sun gear 502 and the other planet gears of the third planetary gear set 214 are supported by bearings within the third carrier 506, which enables the planet gears to rotate about the corresponding centerline axes thereof. In the illustrated example of FIG. 5A, the third planet gear 504 is engaged with the third ring gear 226. In other examples, the third planet gear 504 is engaged with teeth sets 122 of the housing 110 of FIG. 1B.

The third carrier 506 supports (e.g., carries, etc.) the gears of the third planetary gear set 214. In the illustrated example of FIGS. 5A and 5B, the third carrier 506 is rigidly coupled to the sector gear 204 and the output shaft 118. In the illustrated examples of FIGS. 5A and 5B, the third carrier 506 has the same size, shape, and components as the carriers 408, 414 of FIGS. 4A and 4B (e.g., the third carrier 506 includes two annular members similar to the annular members 418 and three cylindrical members similar to the cylindrical members 420, etc.). In the illustrated example of FIGS. 5A and 5B, the third carrier 506 is proximate to the second longitudinal end 220 of the output shaft 118. In other examples, the third carrier 506 has a different size, shape, and/or component(s) than the carriers 408, 414 of FIGS. 4A and 4B.

During operation, the rotation of the third carrier 506 of the second planetary gear set 212 of FIGS. 4A and 4B causes the second intermediate shaft 426 and the third sun gear 502 to rotate about the second axis 304. In some such examples, rotation of the third sun gear 502 causes the third planet gear 504 and the other planet gears of the third planetary gear set 214 to rotate via the engagement therewith. Because the third ring gear 226 is fixed (e.g., unable to rotate, etc.), rotation of the third sun gear 502 causes the planet gears (e.g., the third planet gear 504, etc.) to epicyclically rotate about the third sun gear 502 (e.g., rotation about the second axis 304 and the centerline axis of each planet gear, etc.). For example, during operation, the third planet gear 504 rotates about the second axis 304 and a third centerline axis 508 of the second planet gear 412. The rotation of the third planet gear 504 and the other planet gears of the third planetary gear set 214 about the second axis 304 and the third sun gear 502 causes a corresponding rotation of the third carrier 506. The rotation of the third carrier 506 causes a corresponding rotation of the output shaft 118. Accordingly, rotation of the motor 206 assists the rotation of the output shaft 118 via the planetary gear sets 210, 212, 214. It should be appreciated that the number of teeth of the gears of the third planetary gear set 214 and the quantity of the planetary gears determines the gear reduction (e.g., the relative rotation rate of the second intermediate shaft 426 and the third carrier 506, etc.) of the third planetary gear set 214.

The foregoing examples of steering systems can be used with vehicles. Although each example steering system disclosed above has certain features, it should be understood that it is not necessary for a particular feature of one example steering system to be used exclusively with that example. Instead, any of the features described above and/or depicted in the drawings can be combined with any of the examples, in addition to or in substitution for any of the other features of those examples. Features of one example are not mutually exclusive to features of another example. Instead, the scope of this disclosure encompasses any combination of any of the features.

Example rotary steering systems are disclosed herein. Further examples and combinations thereof include the following:
Example 1 includes a steering gear comprising a first shaft to be coupled to a steering shaft, a second shaft to be coupled to a steering linkage, an input gear set coupling the first shaft to the second shaft, a motor, a first planetary gear set coupled to the motor, and a second planetary gear set coupled to the second shaft, the second planetary gear set coaxially aligned with the first planetary gear set.
Example 2 includes the steering gear of any preceding example, further including a third planetary gear set coupled to the first planetary gear set and the second planetary gear set.
Example 3 includes the steering gear of any preceding example, wherein the third planetary gear set is coaxially aligned with the second planetary gear set.
Example 4 includes the steering gear of any preceding example, wherein the first planetary gear set includes a first sun gear coupled to the motor, a first planet gear engaged to the first sun gear, a first carrier, and the second planetary gear set includes a second sun gear, a second planet gear engaged with the second sun gear, and a second carrier rigidly coupled to the second shaft, and the third planetary gear set includes a third sun gear rigidly coupled to the first carrier, a third planetary gear engaged with the third sun gear, and a third carrier rigidly coupled to the second sun gear.
Example 5 includes the steering gear of any preceding example, wherein the first planetary gear set includes a first ring gear engaged with the first planet gear, and the second planetary gear set includes a second ring gear discrete from the first ring gear, the second ring gear engaged with the second planet gear.
Example 6 includes the steering gear of any preceding example, further including a housing including teeth engaged with the first planet gear.
Example 7 includes the steering gear of any preceding example, wherein the motor is an electric motor.
Example 8 includes the steering gear of any preceding example, wherein the motor includes a third shaft that is coaxial with the second shaft.
Example 9 includes the steering gear of any preceding example, wherein a gear ratio between the motor and the second shaft is at least 1:100.
Example 10 includes the steering gear of any preceding example, wherein the input gear set includes a sector gear concentric with the second shaft, and a pinion rigidly coupled to the first shaft.
Example 11 includes a vehicle including a steering shaft, a steering linkage, and a steering gear assembly including a first shaft coupled to the steering shaft, a second shaft coupled to the steering linkage, an input gear set coupling the first shaft to the second shaft, a motor, a first planetary gear set coupled to the motor, and a second planetary gear set coupled to the second shaft, the second planetary gear set coaxially aligned with the first planetary gear set.
Example 12 includes the vehicle of any preceding example, further including a third planetary gear set coupled to the first planetary gear set and the second planetary gear set.
Example 13 includes the vehicle of any preceding example, wherein the third planetary gear set is coaxially aligned with the second planetary gear set.
Example 14 includes the vehicle of any preceding example, wherein the first planetary gear set includes a first sun gear coupled to the motor, a first planet gear engaged to the first sun gear, a first carrier, and the second planetary gear set includes a second sun gear, a second planet gear engaged with the second sun gear, and a second carrier rigidly coupled to the second shaft, and the third planetary gear set includes a third sun gear rigidly coupled to the first carrier, a third planetary gear engaged with the third sun gear, and a third carrier rigidly coupled to the second sun gear.
Example 15 includes the vehicle of any preceding example, wherein the first planetary gear set includes a first ring gear engaged with the first planet gear, and the second planetary gear set includes a second ring gear discrete from the first ring gear, the second ring gear engaged with the second planet gear.
Example 16 includes the vehicle of any preceding example, further including a housing including teeth engaged with the first planet gear.
Example 17 includes the vehicle of any preceding example, wherein the motor is an electric motor.
Example 18 includes the vehicle of any preceding example, wherein the motor includes a third shaft that is coaxial with the second shaft.
Example 19 includes the vehicle of any preceding example, wherein a gear ratio between the motor and the second shaft is at least 100:1.
Example 20 includes the vehicle of any preceding example, wherein the input gear set includes a sector gear concentric with the second shaft, and a pinion rigidly coupled to the first shaft.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A steering gear comprising:
a first shaft to be coupled to a steering shaft;
a second shaft to be coupled to a steering linkage;
an input gear set coupling the first shaft to the second shaft;
a motor;
a first planetary gear set coupled to the motor; and
a second planetary gear set coupled to the second shaft, the second planetary gear set coaxially aligned with the first planetary gear set.

2. The steering gear of claim 1, further including a third planetary gear set coupled to the first planetary gear set and the second planetary gear set.

3. The steering gear of claim 2, wherein the third planetary gear set is coaxially aligned with the second planetary gear set.

4. The steering gear of claim 2, wherein:
the first planetary gear set includes:
a first sun gear coupled to the motor;
a first planet gear engaged to the first sun gear;
a first carrier; and
the second planetary gear set includes:
a second sun gear;
a second planet gear engaged with the second sun gear; and
a second carrier rigidly coupled to the second shaft; and
the third planetary gear set includes:
a third sun gear rigidly coupled to the first carrier;
a third planetary gear engaged with the third sun gear; and
a third carrier rigidly coupled to the second sun gear.

5. The steering gear of claim 4, wherein:
the first planetary gear set includes a first ring gear engaged with the first planet gear; and
the second planetary gear set includes a second ring gear discrete from the first ring gear, the second ring gear engaged with the second planet gear.

6. The steering gear of claim 4, further including a housing including teeth engaged with the first planet gear.

7. The steering gear of claim 1, wherein the motor is an electric motor.

8. The steering gear of claim 1, wherein the motor includes a third shaft that is coaxial with the second shaft.

9. The steering gear of claim 1, wherein a gear ratio between the motor and the second shaft is at least 100:1.

10. The steering gear of claim 1, wherein the input gear set includes:
a sector gear concentric with the second shaft; and
a pinion rigidly coupled to the first shaft.

11. A vehicle including:
a steering shaft;
a steering linkage; and
a steering gear assembly including:
a first shaft coupled to the steering shaft;
a second shaft coupled to the steering linkage;
an input gear set coupling the first shaft to the second shaft;
a motor;
a first planetary gear set coupled to the motor; and
a second planetary gear set coupled to the second shaft, the second planetary gear set coaxially aligned with the first planetary gear set.

12. The vehicle of claim 11, further including a third planetary gear set coupled to the first planetary gear set and the second planetary gear set.

13. The vehicle of claim 12, wherein the third planetary gear set is coaxially aligned with the second planetary gear set.

14. The vehicle of claim 12, wherein:
the first planetary gear set includes:
a first sun gear coupled to the motor;
a first planet gear engaged to the first sun gear;
a first carrier; and
the second planetary gear set includes:
a second sun gear;
a second planet gear engaged with the second sun gear; and
a second carrier rigidly coupled to the second shaft; and
the third planetary gear set includes:
a third sun gear rigidly coupled to the first carrier;
a third planetary gear engaged with the third sun gear; and
a third carrier rigidly coupled to the second sun gear.

15. The vehicle of claim 14, wherein:
the first planetary gear set includes a first ring gear engaged with the first planet gear; and
the second planetary gear set includes a second ring gear discrete from the first ring gear, the second ring gear engaged with the second planet gear.

16. The vehicle of claim 14, further including a housing including teeth engaged with the first planet gear.

17. The vehicle of claim 11, wherein the motor is an electric motor.

18. The vehicle of claim 11, wherein the motor includes a third shaft that is coaxial with the second shaft.

19. The vehicle of claim 11, wherein a gear ratio between the motor and the second shaft is at least 100:1.

20. The vehicle of claim 11, wherein the input gear set includes:
a sector gear concentric with the second shaft; and
a pinion rigidly coupled to the first shaft.
